(19) United States
(12) Patent Application Publication
(10) Pub. No.: US 2026/0365165 A1
(43) Pub. Date: Nov. 19, 2026

(54) Method and Device for Controlling the Automated Lateral Control of a Vehicle

(71) Applicant: Bayerische Motoren Werke Aktiengesellschaft, Muenchen (DE)

(72) Inventors: Andreas BOESL, Muenchen (DE); Michael STROEBEL, Groebenzell (DE)

(21) Appl. No.: 19/135,426

(22) PCT Filed: Nov. 27, 2023
(86) PCT No.: PCT/EP2023/083206

§ 371 Date: Jun. 4, 2025

(30) Foreign Application Priority Data
Dec. 5, 2022 (DE) 10 2022 132 146.0

(51) Int. Cl. B60W 30/10; B60W 50/00; B60W 50/14; B60W 60/00

(52) U.S. Cl. CPC B60W 30/10; B60W 50/14; B60W 60/001; B60W 2050/0083; B60W 2050/146; B60W 2540/18

(57) ABSTRACT

The present disclosure relates to a device for controlling the automated lateral control of a vehicle. The device is designed to determine a manual steering angle of the steering system of the vehicle which is effected during manual lateral control of the vehicle and to determine, on the basis of the determined manual steering angle, a maximum steering angle which can be set by the steering actuator of the vehicle in the automated lateral control of the vehicle.

### BACKGROUND AND SUMMARY

The invention relates to a method and a corresponding device designed to effectuate particularly reliable and/or precise automated lateral control of a (motor) vehicle, in particular in conjunction with an already recorded reference trajectory.

A vehicle can have an assistance system which is designed to record and store a driving route, in particular a reference trajectory, of the vehicle during an outward journey (in general during a first journey). For example, trajectory data with respect to the driving trajectory traveled by the vehicle when parking in a parking bay and/or when maneuvering can be recorded and stored. The first journey can be effectuated manually by the driver here.

The stored trajectory data with respect to the reference trajectory on the first journey can be used to assist the user, in particular the driver, of the vehicle on a corresponding return journey (in general during a corresponding second journey). At least the lateral control of the vehicle on the corresponding return journey (in general during the second journey) can be effectuated in an automated manner by the vehicle here.

The present document relates to the technical problem of increasing the quality of the lateral control of a vehicle, in particular during a journey along a previously recorded reference trajectory.

The object is addressed by each of the independent claims. Advantageous embodiments are described, inter alia, in the dependent claims. It is to be noted that additional features of a claim dependent on an independent claim, without the features of the independent claim or in combination with only a subset of the features of the independent claim, can form a separate invention independent of the combination of all features of the independent claim, which can be made the subject matter of an independent claim, a divisional application, or a subsequent application. This applies in the same manner to technical teachings described in the description, which can form an invention independent of the features of the independent claims.

According to one aspect, a device for controlling the automated lateral control of a (motor) vehicle is described. The vehicle comprises a (possibly electrical) steering actuator, which is designed to actuate the steering system of the vehicle, for the automated lateral control. The vehicle can have a front wheel steering system and/or a rear wheel steering system here. The features described in this document are each applicable to a front wheel steering system and/or to a rear wheel steering system.

The vehicle can have a storage unit, in which a maximum settable steering angle is stored. The stored maximum settable steering angle can indicate the steering angle of the steering system which can be effectuated at most by the steering actuator in the scope of the automated lateral control. A maximum settable steering angle can be stored in each case for the front wheel steering system and/or for the rear wheel steering system here.

A maximum standard steering angle settable by the steering actuator can be stored in the storage unit. The standard steering angle can have been stored in the storage unit of the vehicle as a standard feature, for example, in the scope of the manufacturing of the vehicle. Alternatively or additionally, the standard steering angle can be equal in each case for a plurality of different vehicles of a uniform vehicle type and/or vehicle model.

A maximum settable standard steering angle can therefore be stored in the storage unit upon delivery of the vehicle. This standard steering angle can be used for the automated lateral control of the vehicle. In particular, the trajectory planning for the automated lateral control can take place under the assumption that the (front wheel and/or rear wheel) steering system has the stored maximum standard steering angle as the maximum possible steering angle. The driving trajectories determined for the automated lateral control therefore typically do not have any steering angles which exceed the stored maximum settable standard steering angle.

The standard steering angle may be defined for a specific vehicle type or for a specific vehicle model. A relatively conservative, i.e. small, standard steering angle is usually stored in the storage unit to take into consideration manufacturing and/or installation tolerances of the steering system of the vehicle. It can thus be ensured that the automated lateral control can be reliably implemented by all vehicles of the specific vehicle type and/or vehicle model. On the other hand, this has the result that the actual maximum settable steering angle of the steering system of a specific vehicle can be greater (in amount) than the standard steering angle. This represents a limitation for the automated lateral control of the specific vehicle.

The device is configured to determine a manual steering angle of the steering system of the vehicle effectuated during manual lateral control of the (specific) vehicle. In particular the maximum manual steering angle can be determined here which is effectuated during a journey using manual lateral control. The (maximum) manual steering angle can be determined, for example, on the basis of the sensor data of a steering angle sensor of the vehicle.

The device is furthermore configured to determine the maximum steering angle of the steering system of the vehicle settable by the steering actuator of the vehicle in the scope of the automated lateral control of the vehicle on the basis of the determined (maximum) manual steering angle. In particular, the maximum settable steering angle for a following journey using automated lateral control can be determined on the basis of the determined (maximum) manual steering angle. The device can be configured in particular to update the maximum settable steering angle stored in the storage unit individually by vehicle on the basis of the determined (maximum) manual steering angle. The standard steering angle can thus be replaced by a vehicle-individual maximum settable steering angle.

The device therefore enables a vehicle-individual adaptation (in particular increase) of the maximum settable steering angle which is used in the scope of the automated lateral control of the vehicle. The quality of the automated lateral control of the vehicle can thus be increased.

The device can be configured to detect that the (maximum) manual steering angle is greater in amount than the maximum settable (standard) steering angle of the steering system of the vehicle stored in the storage unit of the vehicle. In reaction to the detection, the stored maximum settable steering angle can be updated on the basis of the determined (maximum) manual steering angle. A particularly robust and precise update of the stored maximum settable steering angle can thus be effectuated. The updating can take place repeatedly in a corresponding manner at a sequence of successive times during the operation of the vehicle.

The device can be configured to determine an updated maximum settable steering angle on the basis of the determined (maximum) manual steering angle. The maximum settable steering angle stored in the storage unit can be increased here by a (possibly predefined and/or standard) delta value to determine the updated maximum settable steering angle. The delta value is possibly less than the deviation of the stored maximum settable steering angle from the determined manual steering angle. Alternatively or additionally, the delta value can depend on the deviation of the stored maximum settable steering angle from the determined manual steering angle. Therefore, a step-by-step (repeated) adaptation (possibly approximation) of the stored maximum settable steering angle to the respectively determined (maximum) manual steering angle can optionally take place in order to determine the stored maximum settable steering angle in a particularly robust and precise manner.

The device can furthermore be configured to check during a journey using automated lateral control whether the updated maximum settable steering angle of the steering system can actually be implemented by the steering actuator. This can be determined on the basis of the sensor data of the one or more steering angle sensors of the vehicle. The updated maximum settable steering angle can be stored (possibly only then) as the maximum settable steering angle in the storage unit if it is recognized that the updated maximum settable steering angle can be implemented by the steering actuator. The stored maximum settable steering angle can thus be updated in a particularly robust manner.

The device can be configured to determine the (maximum) manual steering angle effectuated in the scope of the respective journey in each case in the scope of a sequence of successive journeys using manual lateral control. Furthermore, the respective stored maximum settable steering angle can be repeatedly updated on the basis of the respectively determined (maximum) manual steering angle. A particularly robust and precise adaptation of the stored maximum settable steering angle can be effectuated by the repeated updating.

The device can be configured, during a journey using manual lateral control, to record a reference trajectory between a first point (for example, a starting point) and a second point (for example, an end point) of the journey. The maximum manual steering angle can be determined here, which was effectuated by the driver of the vehicle during the journey along the reference trajectory.

Furthermore, the device can be configured to recognize that the maximum manual steering angle is greater in amount than the maximum settable steering angle, which is stored in the storage unit of the vehicle for a renewed journey using automated lateral control along the reference trajectory (for example, for a renewed journey in the same direction or in the opposite direction as the original journey). The maximum settable steering angle stored in the storage unit can then be updated on the basis of the determined maximum manual steering angle.

Furthermore, the device can be configured to operate the steering actuator during the renewed journey using automated lateral control along the reference trajectory in order to effectuate steering angles of the steering system of the vehicle up to the maximum settable steering angle stored in the storage unit. The quality of the renewed journey can thus be increased. In particular, it is thus possible to cause the vehicle to follow the previously recorded reference trajectory in a precise manner during the renewed journey.

The device can be configured to plan a driving trajectory for a driving maneuver (in particular for a renewed journey) using automated lateral control on the basis of the determined maximum settable steering angle. The driving trajectory can be planned here such that in the scope of the driving maneuver, the steering angle of the steering system of the vehicle effectuated by the steering actuator reaches but does not exceed the maximum settable steering angle. Particularly comfortable and precise driving maneuvers using automated lateral control can thus be effectuated.

The device can be configured to determine the maximum settable steering angle (possibly stored in the storage unit) on the basis of the determined (maximum) manual steering angle such that the maximum settable steering angle is less (in amount) by a specific offset value than the determined (maximum) manual steering angle. The offset value can possibly be defined by a user of the vehicle. In other words, the device can be configured to reduce the determined manual steering angle in amount by an offset value. The manual steering angle reduced by the offset value can then be stored as the maximum settable steering angle in the storage unit of the vehicle. The comfort of a driving function can thus be further increased.

According to a further aspect, a device for assisting a driver of a vehicle during the (possibly manual) lateral control of the vehicle is described. The measures described in this document are also applicable for this device individually or in combination.

The device is configured to determine a manual steering angle of the steering system of the vehicle effectuated during manual lateral control of the vehicle. Furthermore, the maximum settable steering angle can be determined on the basis of the determined manual steering angle and possibly stored in a storage unit of the vehicle (as described in this document).

Furthermore, the device can be configured to determine a maximum curvature of a driving trajectory of the vehicle during a (following) driving maneuver using lateral control on the basis of the maximum settable steering angle. The lateral control can possibly be effectuated manually by the driver in the context of the driving maneuver. The driver can be assisted here by displaying one or more possible travel trajectories on a display unit (for example, on a display screen) of the vehicle during the lateral control of the vehicle. In particular, the driving trajectory can be displayed to the driver on the display unit (and overlaid with a camera image of the surroundings of the vehicle), which has the maximum possible curvature (and which can be effectuated by the maximum settable steering angle).

Therefore, during the driving maneuver using lateral control, information with respect to the determined maximum curvature (in particular with respect to the driving trajectory having the maximum curvature) can be displayed on the display unit of the vehicle. The comfort of the driver can thus be further increased.

The device can be configured, for example, to determine image data with respect to the surroundings of the vehicle located in front of the vehicle in the direction of travel during the driving maneuver (typically repeatedly) by means of at least one camera (and possibly multiple cameras) of the vehicle. The one or more cameras can be arranged on the front and/or on the rear of the vehicle. Furthermore, the device can be configured to cause a visual representation to be displayed or output on the display unit on the basis of the image data, which representation displays the surroundings of the vehicle overlaid with at least one trajectory. The visual representation can comprise a video of the surroundings of the vehicle. Alternatively or additionally, the visual representation can comprise a schematic representation of the surroundings of the vehicle (for example, a top view representation). The trajectory represented in the visual representation can in particular comprise the trajectory having the maximum curvature (which was determined on the basis of the maximum settable steering angle).

The aspects described in this document relate in particular to a device which can be designed to assist the driver of the (motor) vehicle during a renewed (second) journey along the reference trajectory recorded in the scope of a (prior) first journey. The first journey can comprise an outward journey from the first point (for example, from a starting point) to a second point (for example, to an end point). The second journey can comprise a corresponding return journey from the second point to the first joint. The driver assistance system can therefore be designed to assist the driver during a return journey. Alternatively, the second journey can comprise a repetition of the first journey (in the same direction of travel). The first journey can therefore comprise a journey from the first point to the second point, and the second journey can comprise a renewed journey from the first point to the second point.

According to a further aspect, a (road) motor vehicle (in particular a passenger vehicle or a truck or a bus or a motorcycle) is described, which comprises at least one of the devices described in this document.

According to a further aspect, a method for controlling the automated lateral control of a vehicle is described. The method comprises determining a manual steering angle of the steering system of the vehicle effectuated during manual lateral control of the vehicle. Furthermore, the method comprises determining the maximum steering angle of the steering system of the vehicle settable by the steering actuator of the vehicle in the scope of the automated lateral control of the vehicle on the basis of the determined manual steering angle.

According to a further aspect, a method for assisting a driver of a (motor) vehicle in the (possibly manual) lateral control of the vehicle is described. The method comprises determining a (maximum) manual steering angle of the steering system of the vehicle effectuated during manual lateral control of the vehicle, and determining a maximum settable steering angle on the basis of the determined (maximum) manual steering angle. The method furthermore comprises determining a maximum curvature of a driving trajectory of the vehicle during a (following) driving maneuver using (possibly manual) lateral control on the basis of the maximum settable steering angle. In addition, the method comprises displaying, during the driving maneuver using lateral control, information with respect to the determined maximum curvature on a display unit of the vehicle.

According to a further aspect, a software (SW) program is described. The SW program can be configured to be executed on a processor (for example, on a controller of a vehicle), and to thus carry out at least one of the methods described in this document.

According to a further aspect, a storage medium is described. The storage medium can comprise an SW program which is configured to be executed on a processor and to thus carry out at least one of the methods described in this document.

It is to be noted that the methods, devices, and systems described in this document can be used both alone and in combination with other methods, devices, and systems described in this document. Furthermore, any aspects of the methods, devices, and systems described in this document can be combined with one another in a variety of ways. In particular, the features of the claims can be combined with one another in a variety of ways. Furthermore, features set forth between parentheses are to be understood as optional features.

The invention is described in more detail hereinafter on the basis of exemplary embodiments. In the figures

### BRIEF DESCRIPTION OF THE DRAWINGS

FIG. 1 shows exemplary components of a vehicle;

FIG. 2 shows an exemplary recorded trajectory;

FIG. 3 shows an exemplary display of the steering angle of the vehicle; and

FIG. 4 shows a flow chart of an exemplary method for learning the maximum steering angle settable in the scope of the automated lateral control.

### DETAILED DESCRIPTION OF THE DRAWINGS

As described at the outset, the present document relates to increasing the quality of the automated lateral control of a vehicle, in particular during a journey along a previously recorded and/or planned driving trajectory. A return journey based on an outward journey trajectory recorded during an outward journey is discussed hereinafter. It is to be noted that the described aspects are generally applicable for a second journey which is carried out on the basis of a reference trajectory which was recorded during a first journey. In addition, the described aspects are generally applicable for a journey on the basis of a planned driving trajectory (for example, in a parking and/or maneuvering assistant).

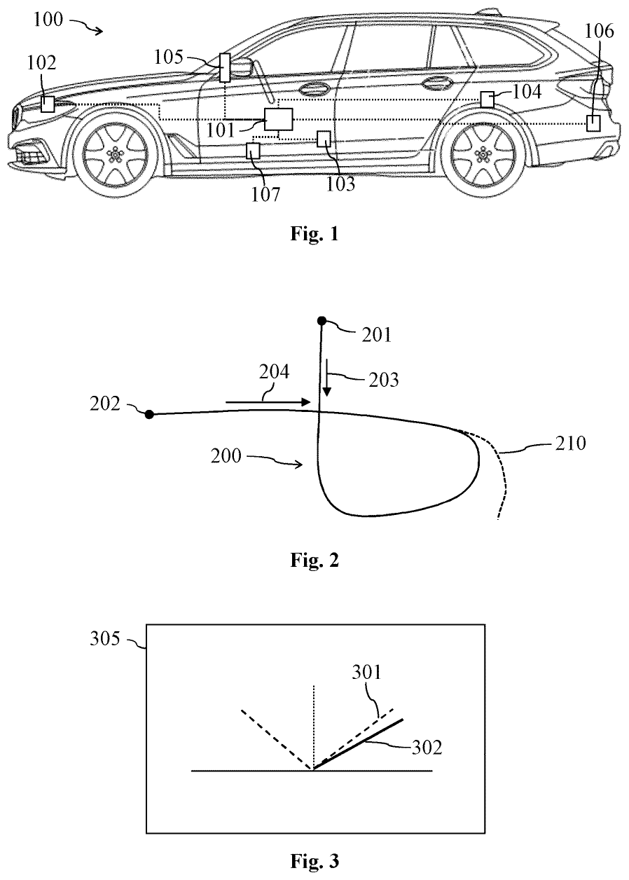

FIG. 1 shows an exemplary vehicle 100 having one or more surroundings sensors 102 (e.g., a camera, a radar sensor, a lidar sensor, an ultrasonic sensor, etc.) and one or more vehicle sensors 103 (e.g., steering sensor, a velocity sensor, an inertial measuring unit (IMU), etc. A (control) device 101 of the vehicle 100 can be configured to capture trajectory data with respect to the outward journey trajectory traveled during the outward journey on the basis of the sensor data of the one or more surroundings sensors 102 and/or on the basis of the one or more vehicle sensors 103 during an outward journey (for example, during a positioning maneuver), and to store these data in a storage unit 107 of the vehicle 100.

The vehicle 100 can furthermore comprise a reversing camera 106, which is configured to acquire image data with respect to the surroundings of the vehicle 100 located in front of the vehicle 100 in the direction of travel of the vehicle 100 during a return journey of the vehicle 100. In particular, the surroundings at the rear of the vehicle 100 can be acquired by the camera 106 during a reversing journey of the vehicle 100.

The vehicle 100 can furthermore comprise one or more longitudinal and/or lateral control actuators 104, which are designed to effectuate at least partially automated longitudinal and/or lateral control of the vehicle 100. Exemplary actuators 104 are a drive motor, a steering device, and/or a braking device. Automated steering of the front axle and/or the rear axle of the vehicle 100 can be effectuated here. The (control) device 101 can be configured to actuate the one or more actuators 104 during a return journey depending on the trajectory data with respect to the outward journey in order to assist the driver of the vehicle 100 during the return journey. In particular the lateral control can be effectuated in an automated manner by the vehicle 100.

Furthermore, the vehicle 100 preferably comprises a user interface 105 having a display unit, which can be arranged, for example, on the dashboard and/or on the head unit of the vehicle 100. The display unit can comprise a display screen (in particular an LCD, LED, or OLED display screen), a projector, and/or a head-up display. The device 101 can be configured to cause the image data of the reversing camera 106 to be displayed on the display unit during a return journey. In particular, the surroundings located in front of the vehicle 100 in the direction of travel can be displayed (in the form of a video).

FIG. 2 shows an exemplary reference trajectory 200 from a starting point 201 to an end point 202, which was recorded on an outward journey 203 (in general on a first journey) and stored. The outward journey trajectory 200 can have arbitrary waypoints in the plane spanned by the x and y axis. The reference trajectory 200 can have been traveled manually by the driver. In particular the steering can have been effectuated manually by the driver in this case. The reference trajectory 200 can be stored as a reference for a driving maneuver in the storage unit 107 of the vehicle 100.

The device 101 of the vehicle 100 can be configured to enable the user of the vehicle 100 to select the stored reference trajectory 200 for a renewed and/or second journey 204. The selection can take place, for example, via the user interface 105. The second journey 204 can be a return journey (from the end point 202 to the starting point 201) or a renewed outward journey (from the starting point 201 to the end point 202). During the second journey 204, the lateral control of the vehicle 100 (for example, by the front wheel steering system and/or the rear wheel steering system) can be effectuated in an automated manner by the vehicle 100 (in particular by one or more steering actuators 104 of the vehicle 100).

The device 101 can be configured to plan a driving trajectory 210 for the (possibly second) journey 204 (in particular on the basis of the reference trajectory 200). In this case, limiting values of the one or more actuators 104, in particular of the front wheel and/or the rear wheel steering system, of the vehicle 100 are typically taken into consideration in the scope of the planning. In particular the maximum settable steering angle of the (front wheel and/or rear wheel) steering system of the vehicle 100 can be taken into consideration. The maximum settable steering angle can be stored in the storage unit 107.

The maximum settable steering angle stored for a vehicle 100 is typically designed relatively conservatively to take into consideration manufacturing and/or installation tolerances of different vehicles 100 of the same vehicle type. As a standard feature, a maximum settable steering angle can be stored which can be reliably performed by (almost) all vehicles 100 of the respective vehicle type even in consideration of tolerances (for example, with a probability of (possibly nearly) 100%). A reliable automated lateral control of the individual vehicles 100 of the vehicle type can thus be effectuated.

The maximum settable steering angle stored as a standard feature is therefore typically smaller (in amount) than the steering angle which can actually be performed by a specific vehicle 100 of the vehicle type. This can have the result that the steering angle manually effectuated by the driver of the vehicle 100 is larger than the maximum settable steering angle which can be effectuated in the scope of the automated lateral control of the vehicle 100. Furthermore, this can have the result that the driving trajectory 210 planned for a second journey 204 deviates from the reference trajectory 200 (recorded in the scope of a manual journey 203).

A deviation between the actual driving trajectory 210 and the reference trajectory 200 can possibly result in a termination of the automated lateral control of the vehicle 100 and as a result thereof in a reduced comfort of the vehicle 100. Furthermore, excessive restriction of the maximum settable steering angle for automated lateral control maneuvers can result in a reduced flexibility of the vehicle 100 when carrying out automated lateral control maneuvers.

The device 101 of the vehicle 100 can be configured to learn the maximum settable steering angle of the vehicle 100 (in a vehicle-specific manner). For this purpose (for example, on the basis of the sensor data of a steering angle sensor of the vehicle 100), the steering angle effectuated in the manual driving operation can be determined (wherein the steering angle effectuated manually by the driver is referred to in this document as the “manual steering angle”). In particular, the maximum manual steering angle can be determined. Furthermore, it can be checked whether the maximum manual steering angle is greater than the stored maximum settable steering angle (in the storage unit 107). If this is the case, an update of the maximum settable steering angle stored in the storage unit 107 can be effectuated.

For example, the maximum manual steering angle can be stored directly as the maximum settable steering angle in the storage unit 107. Particularly rapid learning of the actual maximum settable steering angle can thus be effectuated for the automated lateral control of the vehicle 100.

In a further example, step-by-step learning of the maximum settable steering angle can be effectuated. In reaction to the recognition that the maximum manual steering angle is larger than the stored maximum settable steering angle, the maximum settable steering angle stored in the storage unit 107 can be increased by a specific delta value (for example, 0.1°), in order to determine an updated maximum settable steering angle.

It can be checked in the scope of carrying out an automated lateral control maneuver whether the updated maximum settable steering angle can actually also be set by the actuator 104 of the vehicle 100. If this is the case, the updated maximum settable steering angle can thus be stored in the storage unit 107 as the maximum settable steering angle. If the updated maximum settable steering angle cannot be set by the actuator 104 of the vehicle 100, the previous maximum settable steering angle can thus be retained in the storage unit 107.

The above-mentioned updating method can be repeated to learn the maximum settable steering angle iteratively and/or step-by-step. Particularly robust learning of the maximum settable steering angle can thus be effectuated.

The device 101 can be configured to inform the user, in particular the driver, of the vehicle 100 about the stored maximum settable steering angle. FIG. 3 shows an exemplary optical representation 305, which can be displayed via the display unit of the user interface 105. In this case, for example, during the recording of a reference trajectory 200, the manual steering angle 301 effectuated by the driver can be displayed. Furthermore, the maximum settable steering angle 302 stored in the storage unit 107 can be displayed. The user can thus be informed directly about whether the manually recorded reference trajectory 200 can be implemented in the scope of an automated lateral control maneuver.

As described above, the maximum settable steering angle 302 is typically used for the path or trajectory planning of an automated parking and/or maneuvering function of the vehicle 100, since otherwise a control error could arise in the event of a deviation from the planned trajectory 200, which would not be able to be compensated for by the steering actuator 104 of the vehicle 100. The specification of a generally valid maximum settable steering angle typically takes into consideration manufacturing and installation tolerances, so that the stored value is usually relatively conservative. Therefore, in a vehicle 100, a delta can result between the stored maximum settable steering angle 302 and the steering angle 301 which the driver can set at most themselves. This can result in a deviation during the automated driving along a planned or stored trajectory 200. A further reason for possible deviations between the stored maximum settable steering angle 302 and the maximum manual steering angle 301 can be that no elastomer is possibly installed as a steering stop in the steering system of the vehicle 100, but rather the stop is simulated via software.

A parking and/or maneuvering function of the vehicle 100 can be designed to learn the actual maximum settable steering angle proceeding from the conservatively calculated and parameterized (i.e. stored) value of the maximum settable steering angle 302. For this purpose, the maximum steering angle manually set by the driver can be determined on the basis of the sensor data from one or more sensors 102, 103 of the vehicle 100 and stored (specifically for the vehicle 100). An updated maximum settable steering angle 302 can be determined based on the maximum manual steering angle 301.

During the performance of an automated lateral control maneuver, it can be checked whether the updated maximum settable steering angle can be implemented by the actuator 104 of the vehicle 100.

The maximum manual steering angle 301 can possibly be determined and stored in each case per recording of a trajectory 200. This maximum manual steering angle 301 can then be used when traveling along this trajectory 200 (as the maximum settable steering angle 302). This can possibly only take place if the maximum manual steering angle 301 during the recording of the trajectory 200 is larger than the stored maximum settable steering angle 302.

During the manual driving, the maximum settable steering angle 302 can therefore be learned. This can possibly take place in an iterative manner. A conservative starting value can be selected and if the steering angle 301 set manually by the driver is greater than the currently stored value of the maximum settable steering angle 302, the respective manually set value can be adopted as the stored value. This process can be repeated (possibly permanently) to learn the maximum settable steering angle 302.

Alternatively, to update the stored value, the previously stored value can be increased by a specific delta value to increase the maximum permissible steering angle 302 step-by-step in the direction of the maximum manual steering angle 301. It can be checked here in the scope of an automated lateral control maneuver whether the maximum permissible steering angle 302 increased by the respective delta value can also actually be implemented. If the check was successful, the steering angle 302 can be permanently stored.

The learning of the maximum settable steering angle 302 can possibly take place directly in the assembly plant of the vehicle 100 and/or in the scope of the maintenance of the vehicle 100 (for example, after replacement or repair of the steering) (for example, in the scope of a calibration). This can take place, for example, in the scope of a diagnosis job, a learning journey, and/or a test bench journey.

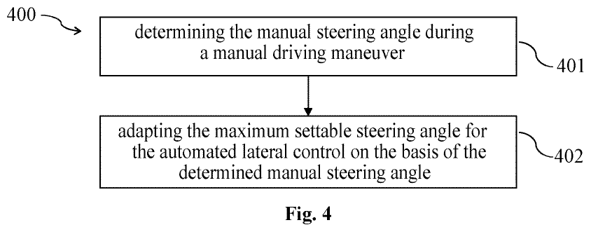

FIG. 4 shows a flow chart of a (possibly computer-implemented) method 400 for controlling the automated lateral control of a (motor) vehicle 100. The method 400 can be carried out, for example, in the scope of a driving function of the vehicle 100, in which the vehicle 100 is laterally controlled in an automated manner along a trajectory 200 (possibly recorded in preparation).

The method 400 comprises determining 401 a manual steering angle 301 of the steering system of the vehicle 100 effectuated during manual lateral control of the vehicle 100. For example, the maximum (in amount) manual steering angle 301 can be determined which was effectuated during a manual journey 203 to record a reference trajectory 200.

Furthermore, the method 400 comprises determining 402 the maximum steering angle 302 settable by the steering actuator 104 of the vehicle 100 in the scope of the automated lateral control of the vehicle 100 on the basis of the determined (maximum) manual steering angle 301. In particular the maximum settable steering angle 302 stored in a storage unit 107 of the vehicle 100 can be updated here on the basis of the determined (maximum) manual steering angle 301.

The quality of the automated lateral control of a vehicle 100, in particular when traveling along a reference trajectory 200 recorded in preparation, can be increased in an efficient and robust manner by the aspects described in this document.

The present invention is not restricted to the exemplary embodiments shown. In particular, it is to be noted that the description and the figures are only to illustrate the principle of the proposed methods, devices, and systems by way of example.

1.-14. (canceled)

15. A device for controlling the automated lateral control of a vehicle, the device comprising a processor configured to:
determine a manual steering angle of a steering system of the vehicle effectuated during manual lateral control of the vehicle; and
determine a maximum steering angle settable by a steering actuator of the vehicle in the scope of the automated lateral control of the vehicle on the basis of the determined manual steering angle.

16. The device according to claim 15, wherein the processor is further configured to:
determine the maximum manual steering angle which is effectuated during a journey using manual lateral control; and
determine the maximum settable steering angle for a subsequent journey using automated lateral control as a function of the determined maximum manual steering angle.

17. The device according to claim 15, wherein the processor is further configured to:
detect that the manual steering angle is greater in amount than a maximum settable steering angle of the steering system of the vehicle stored in a storage unit of the vehicle; and
in response thereto, update the stored maximum settable steering angle on the basis of the determined manual steering angle.

18. The device according to claim 17, wherein the processor is further configured to:
determine an updated maximum settable steering angle on the basis of the determined manual steering angle;
during a journey using automated lateral control, check whether the updated maximum settable steering angle can be implemented by the steering actuator; and
store the updated maximum settable steering angle as the maximum settable steering angle in the storage unit when it is recognized that the updated maximum settable steering angle can be implemented by the steering actuator.

19. The device according to claim 18, wherein:
the processor is configured to increase the maximum settable steering angle stored in the storage unit by a delta value to determine the updated maximum settable steering angle; and
the delta value is less than a deviation of the stored maximum settable steering angle from the determined manual steering angle.

20. The device according to claim 17, wherein the processor is configured to:
repeatedly determine in the scope of a sequence of successive journeys using manual lateral control the manual steering angle effectuated in each case in the scope of the respective journey, in particular the maximum manual steering angle effectuated in the scope of the respective journey; and
repeatedly update the respective stored maximum settable steering angle on the basis of the respectively determined manual steering angle, in particular on the basis of the respectively determined maximum manual steering angle.

21. The device according to claim 15, wherein the processor is configured to:
during a journey using manual lateral control, record a reference trajectory between a first point and a second point of the journey;
determine the maximum manual steering angle which was effectuated by a driver of the vehicle during the journey along the reference trajectory;
recognize that the maximum manual steering angle is greater in amount than the maximum settable steering angle which was stored for a renewed journey using automated lateral control along the reference trajectory in a storage unit of the vehicle; and
update the maximum settable steering angle stored in the storage unit on the basis of the determined maximum manual steering angle.

22. The device according to claim 21, wherein the processor is configured to operate the steering actuator during a renewed journey using automated lateral control along the reference trajectory in order to effectuate the steering angle of the steering system of the vehicle up to the maximum settable steering angle stored in the storage unit.

23. The device according to claim 15, wherein:
the vehicle has a storage unit, in which a maximum standard steering angle settable by the steering actuator is stored;
the standard steering angle is stored as a standard feature in the storage unit of the vehicle in the scope of a manufacturing of the vehicle and/or is identical for a plurality of different vehicles of a uniform vehicle type and/or vehicle model; and
the processor is configured to update the maximum settable steering angle stored in the storage unit individually by vehicle on the basis of the determined manual steering angle.

24. The device according to claim 15, wherein the processor is configured to:
plan a driving trajectory for a driving maneuver using automated lateral control on the basis of the determined maximum settable steering angle; and
plan the driving trajectory such that in the scope of the driving maneuver, the steering angle effectuated by the steering actuator reaches but does not exceed the maximum settable steering angle.

25. The device according to claim 15, wherein the processor is configured to:
reduce the determined manual steering angle in amount by an offset value, and
store the manual steering angle reduced by the offset value as the maximum settable steering angle in a storage unit of the vehicle.

26. A device for assisting a driver of a vehicle in the lateral control of the vehicle, the device comprising a processor configured to:
determine a manual steering angle of a steering system of the vehicle effectuated during manual lateral control of the vehicle;
determine a maximum settable steering angle on the basis of the determined manual steering angle;
determine a maximum curvature of a driving trajectory of the vehicle during a driving maneuver using lateral control on the basis of the maximum settable steering angle; and
during the driving maneuver using lateral control, display information with respect to the determined maximum curvature on a display unit of the vehicle.

27. A method for controlling the automated lateral control of a vehicle, the method comprising:
determining a manual steering angle of a steering system of the vehicle effectuated during manual lateral control of the vehicle; and
determining a maximum steering angle settable by a steering actuator of the vehicle in the scope of the automated lateral control of the vehicle on the basis of the determined manual steering angle.

28. A method for assisting a driver of a vehicle during the lateral control of the vehicle, the method comprising:
determining a manual steering angle of a steering system of the vehicle effectuated during manual lateral control of the vehicle;
determining a maximum settable steering angle on the basis of the determined manual steering angle;
determining a maximum curvature of a driving trajectory of the vehicle during a driving maneuver using lateral control on the basis of the maximum settable steering angle; and
displaying, during the driving maneuver using lateral control, information with respect to the determined maximum curvature on a display unit of the vehicle.
